(19) United States
(12) Patent Application Publication
(10) Pub. No.: US 2026/0048916 A1
(43) Pub. Date: Feb. 19, 2026

(54) PLASTIC PRODUCTS THAT CAN BE RAPIDLY DEGRADED ON-COMMAND

(71) Applicants: University of Maryland, College Park, College Park, MD (US); Green Logic LLC, Takoma Park, MD (US)

(72) Inventors: Srinivasa R. Raghavan, Columbia, MD (US); Mahima Srivastava, College Park, MD (US); Hema Choudhary, Union City, CA (US); Ronald N. Goodman, Takoma Park, MD (US)

(21) Appl. No.: 19/290,052

(22) Filed: Aug. 4, 2025

Related U.S. Application Data
(60) Provisional application No. 63/679,017, filed on Aug. 2, 2024.

(51) Int. Cl. B65D 65/46; C08J 5/18; C08K 3/16; C08K 3/22; C08K 3/28; C08K 5/053; C08L 89/06

(52) U.S. Cl. CPC B65D 65/466; C08J 5/18; C08K 3/16; C08K 3/28; C08K 5/053; C08L 89/06; C08J 2389/06; C08K 2003/2262; C08L 2201/06; C08L 2203/16

(57) ABSTRACT

This present disclosure is directed generally to rapidly degradable polymers, for example, on-demand degradable polymers, products thereof, and methods thereof. In some embodiments, the rapidly degradable polymers degrade in 5 minutes or less in the presence of a peroxide.

### CROSS-REFERENCE TO RELATED APPLICATIONS

This application claims priority to U.S. Application No. 63/679,017, filed on Aug. 2, 2024, the contents of which are hereby incorporated by reference in its entirety.

### FIELD OF THE INVENTION

The field of the invention relates generally to degradable polymers, for example, on-demand degradable polymers. This disclosure also relates to products formed from such degradable polymers, methods of forming such products, and methods of on-demand degradation of such products and/or degradable polymers.

### BACKGROUND

This background information is provided for the purpose of making information believed by the applicant to be of possible relevance to the present invention. No admission is necessarily intended, nor should it be construed, that any of the information disclosed herein constitutes prior art against the present invention.

Plastics are among the most ubiquitous materials used by humans. The term ‘plastic’ refers to polymers like polyethylene (PE), polypropylene (PP), and polystyrene (PS) that are made by polymerizing monomers, with the majority of monomers like ethylene, propylene, and styrene being derived from petrochemical feedstocks. Plastics have become the materials of choice for consumers in a diverse array of applications. This is because they can be shaped and molded into materials with excellent strength-to-weight ratios. Despite their positive attributes, plastics are raising major concerns around the world due to their one major drawback: they are difficult to recycle. Less than 10% of the generated plastic waste is recycled every year.

Plastics that are not recycled typically accumulate in landfills. Because they are made of inert hydrocarbon chains, plastics are quite inert and do not degrade either chemically or via microbes. Thus, the non-degradability of discarded plastics means that they will continue to take up space in landfills even decades after they arrive there. Plastics, due to their slow degradation, contribute significantly to environmental pollution, persisting for centuries in oceans and landfills. Public fears about plastic waste have further increased due to evidence of used plastics being found in the oceans or seas. About 50% of plastics are discarded after a single use and these have been primary targets for legislations. While recycling is promoted as a solution, it faces limitations due to the difficulty of processing various types of plastics and the energy-intensive processes involved.

Recognizing these issues with plastics, plastic manufacturers as well as academic scientists have pursued extensive research to either (a) degrade synthetic plastics, e.g., using novel enzymes; or (b) make plastics derived from natural sources, either of plant or animal origin (referred to as bioplastics). These efforts have had limited success to date, with less-than-ideal efficacy, higher cost, limited acceptance or adoption by consumers, etc.

There is a need for alternative strategies to improve plastic waste management. A solution would be the production of plastic films and solids that can be rapidly degraded by switching on a catalytic reaction.

### SUMMARY

One aspect of the invention pertains to a degradable polymeric product comprising i) a natural polymer (such as proteins, gelatin, fish collagen, polysaccharides, chitosan, agarose, cellulose), ii) a synthetic, biocompatible and biodegradable polymer (such as polyvinyl alcohol (PVA), polyesters, poly(lactic acid) (PLA), poly(lactic-co-glycolic acid) (PLGA)), or iii) a combination thereof, and a catalyst (e.g., silver microparticles, gold microparticles, manganese (IV) oxide, iron (II) oxide, iron (III) oxide, silver nanoparticles, gold nanoparticles, soluble chemicals, iron chloride, microorganisms, enzymes, yeast, catalase, peroxidase). In some embodiments, the degradable polymeric product may be in the form of film, bag, cup, plate, utensil, or plastic film (such as food film). As used herein, the term “degradable polymeric product” refers to a polymeric product that degrades in the presence of a peroxide (such as hydrogen peroxide).

Another aspect of the invention pertains to a bioplastic comprising a natural polymer, a plasticizer, and a catalyst. In some instances, the natural polymer may be combined with one or more synthetic polymers. Furthermore, said natural polymer may be chosen from protein, gelatin, collagen (e.g., fish, bovine, or porcine collagen), polysaccharide, chitosan, agar, agarose, and cellulose and its derivatives, alginate, starch, pectin, carrageenan and natural polyesters such as polyhydroxyalkanoates (e.g., polyhydroxybutyrate). In some embodiments, said bioplastic is a gelatin-based bioplastic. In further embodiments, the bioplastic is a degradable polymeric product and/or is compostable. Furthermore, the bioplastic may be on-demand degradable.

A further aspect of the invention pertains to a method of preparing a degradable polymeric product, said method comprising dissolving a natural polymer, a synthetic polymer, or any combination thereof in a solvent to obtain a solution, adding a catalyst to said solution, and removing said solvent to obtain said polymeric product, wherein said synthetic polymer is a biocompatible and/or biodegradable. In some embodiments, said method further comprises heating said solution and/or adding an acid to said solution.

Another aspect of the invention pertains to a method of degrading a polymeric product, said method comprising contacting a polymeric product disclosed herein with a peroxide (e.g., hydrogen peroxide).

### BRIEF DESCRIPTION OF FIGURES

FIG. 1. Contrasting the state-of-the-art for compostable plastics with the concept advanced in this disclosure. (A) Current “compostable” plastics mostly end up in landfills where they degrade very slowly, if at all. (B) Concept advanced in this disclosure: bioplastics that are robust and usable yet can be degraded ‘on-demand’ after use. Degradation is ‘switched on’ by spraying a solution of H₂O₂: a catalytic reaction ensues by which solid bioplastics are reduced to fragments in minutes. The fragments can be further converted to compost in a day (or less).

FIG. 2. Schematic of the procedure used to synthesize degradable bioplastic films. (A) Gelatin (biopolymer), glycerol (plasticizer) and catalyst are added to warm water. (B) The solution is poured into a Petri dish and cooled to ambient T, whereupon the solution becomes a gel. (C) The gel is dried under ambient conditions to yield a clear, transparent film. Scale bars, 1 cm.

FIG. 3. Degradation of films with H₂O₂. (A) At t=0, 15% v/v of H₂O₂ is sprayed on an intact film. (B) Within seconds, H₂O₂ is decomposed to release O₂ gas bubbles in the film. (C) Small visible holes start to appear. (D) Film disintegrates completely due to formation of larger holes. Scale bars, 1 cm.

FIG. 4. Gelatin films containing different catalysts for H₂O₂ decomposition. (FIG. 4a) 0.5% of manganese dioxide (MnO₂) microparticles (10 μm diameter); (FIG. 4b) Soluble molecules of iron chloride (0.5% FeCl₃); (FIG. 4c) 2% of silver nanoparticles (AgNPs) (size ˜50 nm) (FIG. 4d) 0.1% of the enzyme catalase. Scale bars, 1 cm.

FIG. 5. Effects of different variables on the degradation rate of bioplastic films. The time at the onset of degradation (tₒₙₛₑₜ) is plotted on the y-axis. All films were composed of gelatin and plasticized with glycerol. Films were studied by the protocol in FIG. 3. (FIG. 5a) Varying the concentration of MnO₂. Here, the H₂O₂ was fixed at 20%. (FIG. 5b) Varying the concentration of H₂O₂. Here, the films all contained 0.75% MnO₂. (FIG. 5c) Varying the type of catalyst.

FIG. 6. Mechanical properties of gelatin-based bioplastics. The four samples have different amounts of the plasticizer, glycerol (Gly). Data for the tensile stress vs. strain (measured at an elongation rate of 1.2 mm/min) are shown. The G1 sample (with the highest Gly of 3.3%) is flexible and stretchable, as shown by the photo on the right. As Gly is reduced, the samples become stiffer and the G4 sample (with the lowest Gly of 1%) is rigid and bendable. Scale bars, 1 cm.

FIG. 7. (FIG. 7a) Fabricating hard (or solid) 3D objects based on degradable bioplastics. A hot mixture of gelatin, glycerol, and catalysts is cooled until it becomes viscous. This viscous solution is poured over a mold. As it cools, the gelatin/solution will gel in the shape of the mold. This gel is then dried to form a hard solid. (FIG. 7b) 3D objects based on degradable bioplastics. The objects range from bags (thin and flexible) to weigh boats and containers (thin and stiff) to cups, plates and spoons (stiff and hard). Scale bars, 1 cm.

FIG. 8. Degradation of 3D bioplastic objects upon contact with H₂O₂. Results are shown for (FIG. 8a) A cup of gelatin, with a polypropylene cup as control. (FIG. 8b) A plate of gelatin, with a polystyrene plate as control. In both cases, the gelatin contains 0.1% MnO₂ microparticles. At 1=0, a 15% H₂O₂ solution is sprayed on each object. The control objects are unaffected, whereas the gelatin objects disintegrate completely. The volume of degraded fragments is much smaller than the original volume of the objects.

FIG. 9. Compost set-up used in the lab.

FIG. 10. Composting of degradable bioplastics. (FIG. 10a) Composting results comparing this catalyst-laden bioplastics with commercial compostable materials. (FIG. 10b) The degraded fragments of this bioplastic film completely biodegrade within two days. (FIG. 10c) Remaining area of 4 cm×4 cm films as a function of degradation times in compost at 30° C.

FIG. 11. Coating of gelatin films to make one side hydrophobic. One side is coated with beeswax. Contact angles (CA) of water on the two sides are shown. CA is 94° on the uncoated side and 108° on the coated side. Scale bars, 5 mm.

FIG. 12. Different bioplastic films.

FIG. 13. Degradation of PVA (synthetic polymer) film using 15% H₂O₂ solution.

FIG. 14. Comparison of Mechanical properties of gelatin-based bioplastics and commercial compostable bag (EcoSafe 6400). The two gelatin samples have different amounts of the plasticizer, glycerol (Gly). The G1 sample is flexible and stretchable and has higher Young's modulus Y=246 MPa, as compared to EcoSafe 6400 (Y=166 MPa). As Gly is increased, the sample (G2) becomes more flexible showing higher strain at break, & brk (165%) as compared to 126% for EcoSafe 6400.

FIG. 15. Comparison of mechanical properties of gelatin-based bioplastics of different thickness.

FIG. 16. The gelatin bioplastic cup stays intact when different liquids are poured into it.

### DESCRIPTION

One key advantage of bioplastics is their compostability, i.e., their ability to be biodegraded into compost. Composting of organic matter (leaves and food scraps) is done in a compost heap, where a moist and warm environment is maintained. Microbes then break down the organic matter into a soil-like substance called compost. The compost can be added to soil to restore nutrients, thereby promoting plant growth. Many bioplastic products (e.g., trash bags, grocery bags, disposable plates) are labeled as compostable. As per the American Society for Testing and Materials (ASTM), for a product to be deemed compostable, at least 90% of its weight must disintegrate to sizes below 2 mm within 3 months in a commercial composting facility. In reality, a very small fraction of compostable plastics are taken to composting facilities; mostly they end up in landfills (compostable plastics cannot also be recycled with other plastics). Also, because landfills are designed to have an anaerobic environment where there is no contact with ground water, compostable plastics will not degrade in landfills (or do so very slowly). Indeed, even paper and wood remain undegraded for years in landfills.

Compostable bioplastics are made directly from biopolymers (e.g., proteins like gelatin or polysaccharides like chitosan or alginate) or using polymers made from bioderived monomers (e.g., lactic acid from starch). Currently, polylactic acid (PLA) is the major constituent of compostable products such as disposable plates and packaging materials. PLA degrades by hydrolysis of its ester groups, but this degradation is very slow at room temperature. For PLA (or any other bioplastics) to be composted in a commercial facility, it needs to be in a waste stream dedicated to compostables (i.e., there should be no non-degradable plastics like PE or PP in it). In an industrial compost heap, warm temperatures (50-60° C.) and a moist environment are maintained and the waste is constantly churned. Even with a clean waste stream and these conditions, pure PLA still takes weeks to get composted. Moreover, compostable products typically do not just contain PLA, which is brittle. The presence of other non-degradable plastics will compromise the ability to obtain valuable, nutrient-rich compost.

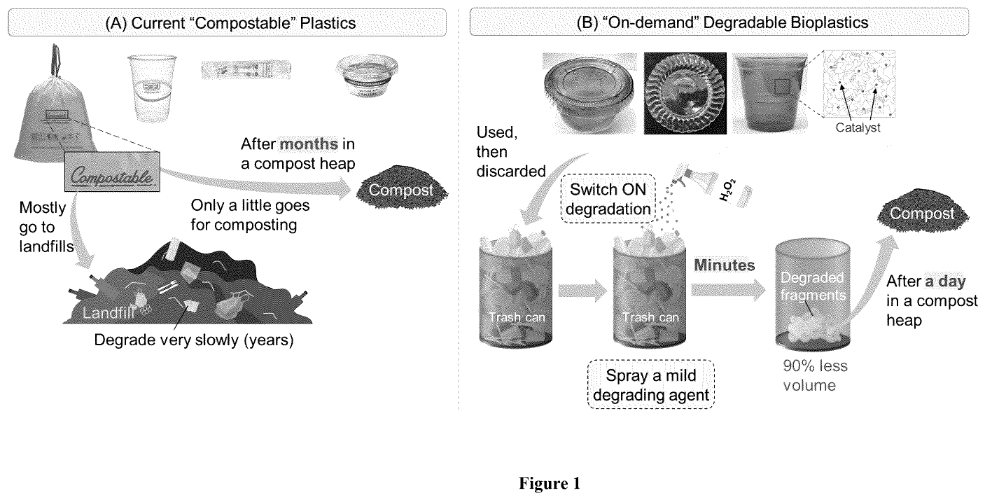

To summarize, the label ‘compostable’ for plastic products may be a misnomer, and this is now being recognized both by scientists as well as environmental activists. Just because it is ‘compostable’ does not mean the product will be composted, and in fact, most plastic waste with that label does not get composted. Moreover, even compostable plastics like PLA require elevated temperatures and long timescales to be degraded into compost. Put simply, none of the existing plastic products degrade quickly or easily. If compostable plastics end up in landfills instead of a composting facility, they will take years to disintegrate at room temperature. The above points are shown graphically in FIG. 1A. It was concluded that the landfill volume required for plastic waste may not be meaningfully reduced even if most plastics are made compostable.

Herein, a new approach to address the ‘plastic waste’ problem is described (FIG. 1B). Bioplastics are made that degrade (disintegrate) into small fragments in minutes—rather than days or weeks—which implies a 100× faster degradation process. At the same time, there was a focus on ensuring that the physical (mechanical) properties of the fast-degrading bioplastics are similar to existing ones. This new bioplastic can thus be a substitute for conventional plastics in typical applications. But once the product has served its purpose and has been discarded, its degradation is switched on by exploiting a catalytic reaction (FIG. 1B). The idea is that the bioplastic has embedded in it a catalyst for the decomposition of hydrogen peroxide (H₂O₂) into oxygen (O₂) gas. Aqueous solutions of H₂O₂ are used as an antiseptic and disinfecting agent for wounds, to sterilize and sanitize medical equipment in hospitals, and in various industries. Thus, H₂O₂ is a safe liquid, which is used here as a ‘degrading agent’. FIG. 1B shows a collection of used bioplastics in a trash can. The degrading agent (H₂O₂) is sprayed onto this waste, and the H₂O₂ seeps into the materials. Bubbles of O₂ are generated and these induce large holes in each material. Within minutes, the materials disintegrate into small fragments. This step alone reduces the volume of the waste by up to 90%. The overall concept is termed on-demand degradation.

This on-demand degradability can be conferred to a range of bioplastics (as well as conventional plastics). For most of the initial proof-of-concept experiments, the protein, gelatin was selected as the matrix of choice. It was further shown that, after gelatin-based bioplastics are catalytically degraded, the remaining small fragments (FIG. 1B) can be collected and added directly to a compost heap. These fragments completely degrade into compost relatively quickly, i.e., in a day, rather than weeks. The faster composting is facilitated by the small size of the fragments, which increases the surface area for microbial action. Overall, the bioplastics have the potential to truly serve as degradable and compostable alternatives to conventional plastics.

### Definitions

For the purposes of promoting an understanding of the principles of the invention, reference will now be made to certain embodiments, and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Moreover, all ranges disclosed herein are to be understood to encompass any and all subranges (including all fractional and whole values) subsumed therein.

The term “compostable” as used herein refers to controlled, aerobic, biological decomposition of biodegradable materials. As per the American Society for Testing and Material (ASTM), for a product to be deemed compostable, at least 90% of its weight must disintegrate to sizes below 2 mm within 3 months in a commercial composting facility. In some embodiments, the term “compostable” as used herein refers to a product wherein at least 90% of its weight disintegrates to sizes below 2 mm in under 3 months. In further embodiments, the term “compostable” as used herein refers to a product wherein at least 90% of its weight disintegrates to sizes below 2 mm in 2 months or less. In some embodiments, the term “compostable” as used herein refers to a product wherein at least 90% of its weight disintegrates to sizes below 2 mm in 1 month or less. In some embodiments, the term “compostable” as used herein refers to a product wherein at least 90% of its weight disintegrates to sizes below 2 mm in 1 week or less. In some embodiments, the term “compostable” as used herein refers to a product wherein at least 90% of its weight disintegrates to sizes below 2 mm in 48 hours or less. In some embodiments, the term “compostable” as used herein refers to a product wherein at least 90% of its weight disintegrates to sizes below 2 mm in 24 hours or less. In some embodiments, the term “compostable” as used herein refers to a product wherein at least 90% of its weight disintegrates to sizes below 2 mm in 1 hour or less. In some embodiments, the term “compostable” as used herein refers to a product wherein at least 90% of its weight disintegrates to sizes below 2 mm in 30 minute or less. In some embodiments, the term “compostable” as used herein refers to a product wherein at least 90% of its weight disintegrates to sizes below 2 mm in 10 minutes or less. In some embodiments, the term “compostable” as used herein refers to a product wherein at least 90% of its weight disintegrates to sizes below 2 mm in 5 minutes or less.

The term “degradable” as used herein refers to the ability of a substance, like waste or packaging, to be broken down into simpler, less complex forms, either through chemical or biological processes.

The term “biodegradable” as used herein refers to the ability of a substance to decompose one or more processes involving bacteria and/or other living organisms.

The term “plasticizer” as used herein refers to a substance added to a synthetic resin to produce or promote plasticity and flexibility and to reduce brittleness.

The term “polymer” as used herein is used interchangeably with “plastic” and “polymeric product” to refer to a substance that has a molecular structure consisting of mainly or entirely similar units bonded together. More particularly, the term “polymeric product” as used herein is used interchangeable with “plastic” and “polymeric product” to refer to a product comprising a natural polymer, a synthetic polymer, or any combination thereof, a plasticizer, and a catalyst. The polymeric product may be degradable and/or compostable. In some instances, said polymeric product is a bioplastic. The bioplastic may be derived from collagen such as fish, bovine, or porcine collagen.

In some embodiments, the term “plastic” includes “bioplastic”. The term “bioplastic” as used herein refers to a plastic derived from renewable biomass sources like corn starch and sugarcane, collagen or microbes. Bioplastic includes plastic made from natural polymers such as protein, gelatin, collagen, polysaccharide, chitosan, agar, agarose, and cellulose and its derivatives, alginate, starch, pectin, carrageenan and natural polyesters such as polyhydroxyalkanoates (e.g., polyhydroxybutyrate). As used herein, the term “bioplastic” includes gelatin-based bioplastics. More particularly, gelatin-based bioplastics are bioplastics derived from gelatin (a protein derived from collagen, such as fish collagen).

The term “natural polymer” as used herein refers to a polymer that is found in nature and can be extracted from plants, animals or other natural sources such as protein, gelatin, collagen, polysaccharide, chitosan, agar, agarose, and cellulose and its derivatives, alginate, starch, pectin, carrageenan and natural polyesters such as polyhydroxyalkanoates (e.g., polyhydroxybutyrate).

The term “synthetic polymer” as used herein refers to a human-made polymer created through chemical reactions, typically involving the joining of smaller molecules into long chains.

The terms “on-demand degradable” and “on-demand degradability” as used herein is used interchangeably with “on-command degradable” and “on-command degradability” to mean degradation of a polymeric (or plastic or bioplastic) product disclosed herein which reduces the volume of the polymeric (or plastic or bioplastic) product by up to about 90% in 3 months or less, in 2 months or less, in 1 months or less, in 1 week or less, in 48 hours or less, in 24 hours or less, in 1 hour or less, in 30 minutes or less, in 10 minute or less, or in 5 minutes or less. Degradation may occur by contacting a polymeric (or plastic or bioplastic) product disclosed herein with a peroxide such as hydrogen peroxide. In some, embodiments, the polymeric (or plastic) product is a “rapidly degradable polymer”. In particular, rapidly degradable polymer as used herein refers to degradation of a polymeric (or plastic) product disclosed herein (optionally in the presence of a peroxide, such as hydrogen peroxide) up to about 90% in 1 months or less, in 1 week or less, in 48 hours or less, in 24 hours or less, in 1 hour or less, in 30 minutes or less, in 10 minute or less, or in 5 minutes or less. In some embodiments, the rapidly degradable polymer is compostable.

In some embodiments, on-demand degradation occurs in 3 months or less. In some embodiments, on-demand degradation occur in 2 months or less. In some embodiments, on-demand degradability occurs in 1 month or less. In some embodiments, on-demand degradation occurs in 1 week or less. In some embodiments, on-demand degradation occurs in 48 hours or less. In some embodiments, on-demand degradation occurs in 24 hours or less. In some embodiments, on-demand degradability occurs in 1 hour or less. In some embodiments, on-demand degradation occurs in 30 minutes or less. In some embodiments, on-demand degradation occurs in 10 minute or less. In some embodiments, on-demand degradation occurs in 5 minutes or less.

In some embodiments on-demand degradability means that the material is stable under normal conditions and in the presence of regular solvents like water, alcohol and other liquids, and which will start to degrade only when H₂O₂ comes into contact with said material (e.g., via spraying on the surface).

The term “biocompatible” as used herein refers to a material or substance that is not harmful to living tissue.

The term “degradable polymeric product” refers to a polymeric product that degrades in the presence of peroxide (e.g., hydrogen peroxide or calcium peroxide). In some embodiments, hydrogen peroxide that is applied to the surface of the polymeric product has a concentration of about 0.1% to about 3.5%, or about 0.1 to about 6%, or about 0.1% to about 10%, or about 0.1% to about 20%, or about 0.1 to about 35%, or about 0.1% to about 50%. In various embodiments, the (hydrogen) peroxide solution applied to the surface has a contention of from about 0.1% to about 35%, about 1% to about 10%, about 2% to about 6%, or about 3%. As understood in the art, low concentration (e.g., ≤10%) is readily available to consumers, with ˜3% being most common (e.g. via OTC pharmacies and supermarkets). Medium (e.g., 10-35%) and higher (e.g., ≥35%) solutions may also be used, but such concentrations may necessitate protective equipment.

The terms “degrade” or “degrades” as used herein refers to chemical deterioration of a degradable polymeric product disclosed herein.

### LIST OF EMBODIMENTS

The following is a non-limiting list of embodiments:

1. A polymeric product, said polymeric product comprising a natural polymer, a synthetic polymer, or any combination thereof, a plasticizer, and a catalyst. The polymeric product may be a bioplastic (such as a gelatin-based bioplastic).

2. The polymeric product of embodiment 1, wherein said natural polymer is chosen from protein, gelatin, collagen, polysaccharide, chitosan, agar, agarose, and cellulose and its derivatives, alginate, starch, pectin, carrageenan, and natural polyesters. Combinations of two or more natural polymers may also be used in the various embodiments herein.

3. The polymeric product of embodiment 2, wherein said collagen is fish, bovine, porcine, ovine, or poultry collagen. Combinations of two or more collagens may also be used in the various embodiments herein.

4. The polymeric product of any one of embodiments 1 to 3, wherein said synthetic polymer is polyvinyl alcohol (PVA), polyesters, poly(lactic acid) (PLA), poly(lactic-co-glycolic acid) (PLGA), polyethylene oxide, polypropylene oxide, or polycaprolactone. Combinations of two or more synthetic polymers may also be used in the various embodiments herein.

5. The polymeric product of any one of embodiments 1 to 4, wherein said plasticizer is glycerol, sorbitol, mannitol, ethylene glycol, polyethylene glycol (PEG), propylene glycol, or polypropylene glycol (PPG). Further examples of suitable plasticizers which may be in addition or alternate to those above include other polyol-based plasticizers (e.g., xylitol, erythritol, triethanolamine, and trimethylolpropane), other glycols (e.g., butylene glycol, neopentyl glycol, hexylene glycol, and diethylene glycol), lactate-based and ester plasticizers (e.g., ethyl lactate, glycerol monoacetate/diacetate, and triacetin), citrate-based plasticizers (e.g., triethyl citrate, acetyl tributyl citrate, and tributyl citrate), fatty acid derivatives (e.g., epoxidized soybean oil, glyceryl monooleate, and castor oil derivatives), and polymeric plasticizers (e.g., polyethylene oxide, polycaprolactone, and oligomeric PLA).

6. The polymeric product of any one of embodiments 1 to 5, wherein said catalyst is chosen from microparticles, nanoparticles, soluble chemicals, microorganisms, and enzymes. Combinations of two or more catalysts may also be used in the various embodiments herein.

In various embodiments, said catalyst is chosen from transition metal catalysts, organometallic catalysts (e.g., Iron-based catalysts, cobalt-based catalysts, and manganese-based catalysts), enzyme-mimetic catalysts (e.g., mettallocenes), photocatalysts (e.g., iron porphyrin, and Mn-porphyrins), and combinations thereof. Further catalysts which may be used include copper-based catalysts, pallidum catalysts, platinum catalysts, ruthenium-based catalysts, bimetallic and alloy catalysts, metal oxide catalysts, perovskite catalysts, and combinations thereof. Again, combinations of two or more catalysts may also be used in the various embodiments herein.

In various embodiments, said microparticles are chosen from silver microparticles, gold microparticles, manganese (IV) oxide (MnO₂) and iron oxide (Fe₂O₃, Fe₃O₄), titanium oxide (TiO₂), and combinations thereof.

In various embodiments, said nanoparticles are chosen from gold nanoparticles, silver nanoparticles, and combinations thereof.

In various embodiments, said soluble chemicals are chosen from iron chloride, ferrous sulfate (FeSO₄), ferrous chloride (FeCl₂), manganese sulfate (MnSO₄), manganese chloride (MnCl₂), and combinations thereof.

In various embodiments, said microorganisms comprise yeast. In further or other embodiments, said microorganisms are chosen from bacteria, fungi, and combinations thereof. In various embodiments, the bacteria are selected from Ideonella sakaiensis, Pseudomonas putida, Rhodococcus ruber, Bacillus subtilis, Alcanivorax borkumensis, and combinations thereof. In various embodiments, the fungi are selected from Aspergillus niger, Aspergillus tubingensis, Penicillium simplicissimum, Fusarium solani, Candida spp., Yarrowia lipolytica, Phanerochaete chrysosporium, Trametes versicolor, and combinations thereof.

In various embodiments, said enzymes are chosen from catalase, peroxidase, laccase, and combinations thereof.

7. The polymeric product of embodiment 6, wherein said microparticles have a size (or an average size) of about 1 μm to about 100 μm.

8. The polymeric product of embodiment 6, wherein said nanoparticles have a size (or an average size) of about 5 nm to about 100 nm.

9. A degradable polymeric product, said polymeric product comprising a natural polymer, a synthetic polymer, or any combination thereof, a plasticizer, and a catalyst. In some embodiments, said polymeric product is on-demand degradable. In further embodiments, said polymeric product is a bioplastic.

10. The degradable polymeric product of embodiment 9, wherein said natural polymer is chosen from protein, gelatin, collagen, polysaccharide, chitosan, agarose, or cellulose and its derivatives, alginate, starch, pectin, carrageenan, and natural polyesters such as polyhydroxyalkanoates (e.g., polyhydroxybutyrate).

11. The degradable polymeric product of embodiment 10, wherein said collagen is fish, bovine, porcine, ovine, or poultry collagen.

12. The degradable polymeric product of any one of embodiments 9 to 11, wherein said synthetic polymer is polyvinyl alcohol (PVA), polyesters, poly(lactic acid) (PLA), or poly(lactic-co-glycolic acid) (PLGA), polyethylene oxide, polypropylene oxide, and polycaprolactone.

13. The degradable polymeric product of any one of embodiments 9 to 12, wherein said plasticizer is glycerol, sorbitol, mannitol, ethylene glycol, polyethylene glycol (PEG), propylene glycol, polypropylene glycol (PPG).

14. The degradable polymeric product of any one of embodiments 9 to 13, wherein said catalyst is chosen from microparticles, nanoparticles, soluble chemicals, microorganisms, and enzymes.

15. The degradable polymeric product of embodiment 14, wherein said microparticles are chosen from silver microparticles, gold microparticles, manganese (IV) oxide (MnO₂) and iron oxide (Fe₂O₃, Fe₃O₄), and titanium oxide (TiO₂).

16. The degradable polymeric product of embodiment 14 or 15, wherein said microparticles have a size (or an average size) of about 1 μm to about 100 μm.

17. The degradable polymeric product of any one of embodiments 14 to 16, wherein said nanoparticles are chosen from gold nanoparticles, or silver nanoparticles.

18. The degradable polymeric product of any one of embodiments 14 to 17, wherein said nanoparticles have a size (or an average size) of about 5 nm to about 100 nm.

19. The degradable polymeric product of any one of embodiments 14 to 18, wherein said soluble chemicals are chosen from iron chloride, ferrous sulfate (FeSO₄), ferrous chloride (FeCl₂), manganese sulfate (MnSO₄), and manganese chloride (MnCl₂).

20. The degradable polymeric product of any one of embodiments 14 to 19, wherein said microorganisms is yeast.

21. The degradable polymeric product of any one of embodiments 14 to 20, wherein said enzymes are chosen from catalase, peroxidase, laccase, and combinations thereof.

22. The degradable polymeric product of any one of embodiments 9 to 21, wherein said degradable polymeric product is rapidly degradable polymer. In some embodiments, said degradable polymeric product is a rapidly degradable polymer. In further embodiments, said rapidly degradable polymer is compostable. In further embodiments, said rapidly degradable on-command by, for example, contacting said polymer with a peroxide.

23. The degradable polymeric product of any one of embodiments 9 to 22, wherein said degradable polymeric product is degradable on-demand (or on-command) when said degradable polymeric product is contacted with a peroxide.

24. The degradable polymeric product of embodiment 23, wherein said peroxide comprises or is hydrogen peroxide. Further examples of suitable peroxides which may be in addition or alternate to hydrogen peroxide include organic peroxides (e.g., benzoyl peroxide, dicumyl peroxide, and tert-butyl peroxide derivatives), other inorganic peroxides and peroxy compounds (e.g., peracetic acid, and sodium percarbonate), photo-activable peroxides (e.g., di-tert butyl peroxide, and cumene hydroperoxide), and peroxy acids and related oxidants (e.g., m-Chloroperoxybenzoic acid), and combinations thereof. Further examples of inorganic peroxides include sodium peroxide, calcium peroxide, magnesium peroxide, zinc peroxide, carbamide peroxide, and combinations thereof. In various embodiments, said peroxide comprises hydrogen peroxide given that it is readily available to consumers.

25. The degradable polymeric product of embodiment 24, wherein said peroxide (or hydrogen peroxide) has a concentration of about 0.1% to about 30%, or about 1% to about 20%, or about 3% to about 15%.

26. The degradable polymeric product of any one of embodiments 9 to 25, wherein said degradable polymeric product is compostable in 5 minutes or less.

27. The degradable polymeric product of any one of embodiment 9 to 25, wherein said degradable polymeric product is compostable in 10 minutes or less.

28. The degradable polymeric product of any one of embodiments 9 to 25, wherein said degradable polymeric product is compostable in 30 minutes or less.

29. The degradable polymeric product of any one of embodiments 9 to 25, wherein said degradable polymeric product is compostable in 1 hour or less.

30. The degradable polymeric product of any one of embodiments 9 to 25, wherein said degradable polymeric product is compostable in 12 hours or less.

31. The degradable polymeric product of any one of embodiments 9 to 25, wherein said degradable polymeric product is compostable in 24 hours or less.

32. The degradable polymeric product of any one of embodiments 9 to 25, wherein said degradable polymeric product is compostable in 1 week or less.

33. The degradable polymeric product of any one of embodiments 9 to 25, wherein said degradable polymeric product is compostable in 1 month or less.

34. The degradable polymeric product of any one of embodiments 9 to 25, wherein said degradable polymeric product is compostable in 3 months or less.

35. The degradable polymeric product of any one of embodiments 9 to 25, wherein said polymeric product is a polymer film or 3D object.

36. The degradable polymeric product of any one of the preceding embodiments, wherein said catalyst is embedded in the polymer film or 3D object.

37. The degradable polymeric product of any one of the preceding embodiments, wherein said product is a single use plastic product.

38. The degradable polymeric product of any one of the preceding embodiments, wherein said product is in the form of bag, cup, plate, utensil, food film, food containers with lids, clamshell boxes, straws, zip bags, and wrappers. One of skill will appreciate that various products can be formed from the degradable polymeric composition of this disclosure, including packaging and disposable products, textiles and apparel, consumer goods and toys, kitchenware and household items, personal care and hygiene products, office and electronic products, gardening and agriculture products, pet products, cleaning products, etc. In various embodiments, the degradable polymeric product is in the form of food containers or clamshells, disposable cutlery, plates, or cups; yard waste, kitchen, shopping, or produce bags; food, snack, or coffee wrappers; blister packs, stretch film or shrink wrap; or a combination thereof.

39. A method of preparing a degradable polymeric product, said method comprising dissolving a natural polymer, a synthetic polymer, or any combination thereof in a solvent, adding a catalyst, and removing said solvent to obtain said degradable polymeric product.

In various embodiments, the method comprises simply combining the polymer(s) with the solvent. Said another way, the polymer(s) may not be “dissolved” per se but may simply be dispersed or carried in the solvent (or carrier). In some embodiments, the polymer(s) may absorb (or swell with) the solvent. The solvent can be used in various amounts, and such amounts can be determined via routine experimentation. In general, the amount of solvent is such that at least all of the polymer is covered or immersed.

In various embodiments, the catalyst is embedded or entrained in the polymeric product. The catalyst may be uniformly disposed or dispersed throughout the polymeric product (or polymeric matrix). Otherwise, the catalyst may be in one or more localized or concentrated areas or in a concentration gradient.

In many embodiments, the catalyst is substantially or completely inert with respect to other components which may be present in and/or during manufacture of the polymeric product. Said another way, the catalyst is generally different from one that may conventionally be used to facilitate polymerization of monomers into oligomers and polymers.

After combination, the polymer(s) and solvent can be mixed or stirred to facilitate dispersion. The same is true after combining the polymer/solvent mix and the catalyst. The resulting solution may be held for a period or further processed shortly after formation.

The solvent can be removed from the solution by conventional methods and processes understood in the art. For example, the solution may be heated to volatilize or evaporate the solvent. In general, the temperature should be lower than that which would potentially degrade the polymer(s) and/or catalyst(s). Reduced pressure (or vacuum) may also be applied to facilitate removal of the solvent.

40. The method of embodiment 39, wherein said natural polymer is chosen from protein, gelatin, collagen, polysaccharide, chitosan, agarose, and cellulose and its derivatives, alginate, starch, pectin, carrageenan, and natural polyesters such as polyhydroxyalkanoates (e.g., polyhydroxybutyrate).

41. The method of embodiment 40, wherein said collagen is fish, bovine, porcine, ovine, or poultry collagen.

42. The method of any one of embodiments 39 to 41, wherein said synthetic polymer is polyvinyl alcohol (PVA), polyesters, poly(lactic acid) (PLA), and poly(lactic-co-glycolic acid) (PLGA), polyethylene oxide, polypropylene oxide, or polycaprolactone.

43. The method of any one of embodiments 39 to 42, wherein said plasticizer is glycerol, sorbitol, mannitol, ethylene glycol, polyethylene glycol (PEG), propylene glycol, or polypropylene glycol (PPG).

44. The method of any one of embodiments 39 to 43, wherein said catalyst is chosen from microparticles, nanoparticles, soluble chemicals, microorganisms, and enzymes.

45. The method of embodiment 44, wherein said microparticles are chosen from silver microparticles, gold microparticles, manganese (IV) oxide (MnO₂), iron oxide (Fe₂O₃, Fe₃O₄), and titanium oxide (TiO₂).

46. The method of embodiment 44 or 45, wherein said microparticles have a size (or an average size) of about 1 μm to about 100 μm.

47. The method of any one of embodiments 44 to 46, wherein said nanoparticles are chosen from gold nanoparticles, or silver nanoparticles.

48. The method of any one of embodiments 44 to 47, wherein said nanoparticles have a size (or an average size) of about 5 nm to about 100 nm.

49. The method of any one of embodiments 44 to 48, wherein said soluble chemicals are chosen from iron chloride, ferrous sulfate (FeSO₄), ferrous chloride (FeCl₂), manganese sulfate (MnSO₄), and manganese chloride (MnCl₂).

50. The method of any one of embodiments 44 to 49, wherein said microorganisms is yeast.

51. The method of any one of embodiments 44 to 50, wherein said enzymes are chosen from catalase, peroxidase, and laccase.

52. The method of any one of embodiments 39 to 51, wherein said catalyst is in the concentration of about 0.01% to about 10%, or about 0.01% to about 1%, or about 0.1% to about 1%.

53. The method of any one of embodiments 39 to 52, wherein said solvent is water.

54. The method of any one of embodiments 39 to 53, further comprising heating said solution and/or adding an acid.

55. The method of any one of embodiments 39 to 54, wherein said polymeric product is shaped into a mold.

56. A method of degrading a degradable polymeric product, said method comprising contacting a polymeric product of any of the preceding embodiments with a peroxide.

In various embodiments, the polymeric product is one which has been “used” at least one time, e.g. by a consumer. For example, the polymeric product may have contained (or still contain) food wastes or other compostable items, e.g., leaves, branches, etc.

The polymeric product may be prepared prior to contacting with the peroxide. For example, the polymeric product may be washed or otherwise cleaned. The polymeric product can also be broken down into smaller pieces to increase surface area thereof, e.g., by cutting, tearing, shredding, etc.

The polymeric product and peroxide may be combined in various ways. For example, the peroxide may be sprayed, poured, brushed, dabbed, dropped, misted, fogged, rolled, or otherwise applied on to the polymeric product. Otherwise, the polymeric product may be submerged, soaked, or other otherwise immersed by the peroxide. In various embodiments, a user can simply place the polymeric product in a vessel (e.g., a waste bin, can, etc.) and apply the peroxide (e.g., by spraying) to facilitate degradation. In specific embodiments, the polymeric product and peroxide can be combined via the system described in U.S. Pat. No. 12,252,451.

Light such as UV light may be applied in certain instances to further facilitate degradation. For example, the coated polymeric product may simply be placed in sunlight. Otherwise, more industrial methods may be used to irradiate the product.

The coated polymeric product may be mixed, blended, stirred, tumbled, rolled, etc. to facilitate degradation. Such processes may be carried out until a predetermined maximum particle or piece size is achieved.

The degraded product can then be further processed, composted, or otherwise disposed of. If peroxide remains, at least a portion thereof may be separated for further use or left to further decompose. In various embodiments, at least a portion of residual catalyst(s) (if any) is separated from the degraded product. This is helpful reduce overall cost and may be useful to address any potential concerns should the catalyst(s) remain in, e.g., the waste or composted product. 57. The method of embodiment 56, wherein said degradable polymeric product degrades on-command.

58. The method of embodiment 56 or 57, wherein said peroxide is hydrogen peroxide.

59. The method of embodiment 58, wherein said hydrogen peroxide has a concentration of about 0.1% to about 30%.

60. The method of any one of embodiments 56 to 59, wherein said degradable polymeric product degrades to about 10% volume of the original size.

61. The method of any one of embodiments 56 to 60, wherein said degradable polymeric product is compostable in 5 minutes or less.

62. The method of any one of embodiments 56 to 60, wherein said degradable polymeric product is compostable in 10 minutes or less.

63. The method of any one of embodiment 56 to 60, wherein said degradable polymeric product is compostable in 30 minutes or less.

64. The method of any one of embodiments 56 to 60, wherein said degradable polymeric product is compostable in 1 hour or less.

65. The method of any one of embodiments 56 to 60, wherein said degradable polymeric product is compostable in 12 hours or less.

66. The method of any one of embodiments 56 to 60, wherein said degradable polymeric product is compostable in 24 hours.

67. The method of any one of embodiments 56 to 60, wherein said degradable polymeric product is compostable in 1 week or less.

68. The method of any one of embodiments 56 to 60, wherein said degradable polymeric product is compostable in 1 month or less.

69. The method of any one of embodiments 56 to 60, wherein said degradable polymeric product is compostable in 3 months or less.

70. A container, said container comprising a degradable polymer product of any one of the preceding embodiments and optionally, a peroxide. In further embodiments, the peroxide is present.

71. The container of embodiment 70, wherein said peroxide is hydrogen peroxide.

72. The container of embodiment 70 or 71, wherein said peroxide (or said hydrogen peroxide) has a concentration of about 0.1% to about 3.5%, or about 0.1% to about 6%, or about 0.1% to about 10%, or about 0.1% to about 20%, or about 0.1% to about 50%.

### EXAMPLES

The following examples are provided solely to illustrate the present invention and are not intended to limit the scope of the invention, described herein. Further details to illustrate the present invention may be found in the manuscript entitled: Raghavan, S. R. et al., Plastic Products that Can be Rapidly Degraded On-Demand (in preparation), which is incorporated by reference.

### Example 1. Degradation of Catalyst-Loaded Polymer Films by H₂O₂

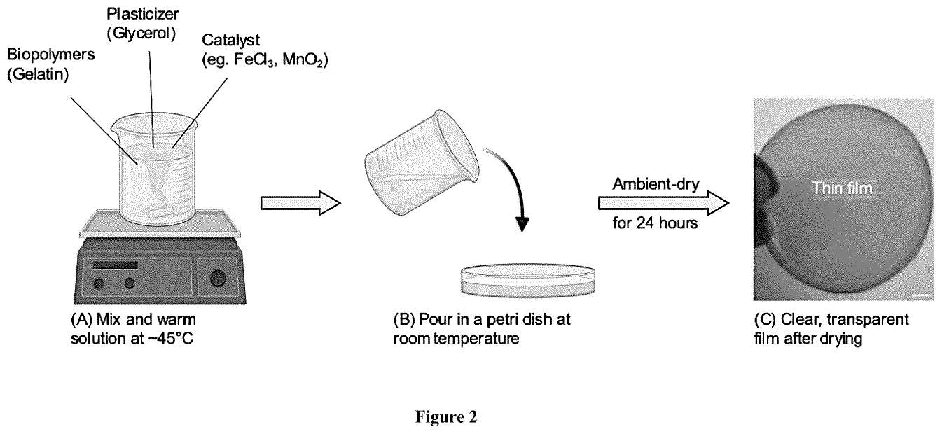

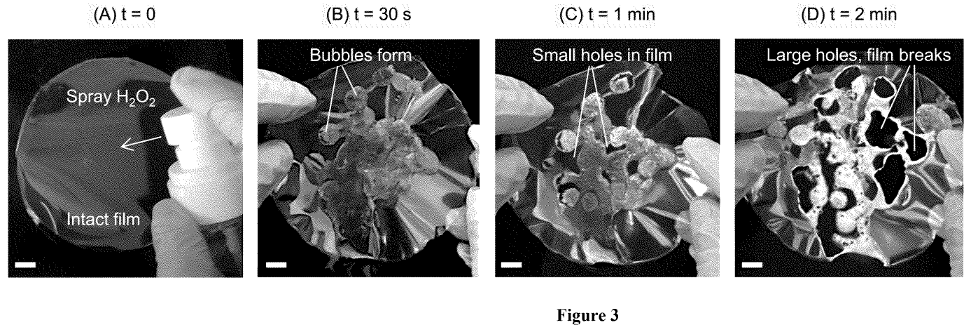

Bioplastic films containing catalysts were synthesized by the procedure in FIG. 2. The typical biopolymer used as the matrix for the films is the protein gelatin. Gelatin is the denatured form of the protein collagen, which is a major structural protein in animals.³⁵ Food-grade gelatin goes by the tradename Jell-OR in the US. 10% gelatin is dissolved in water by heating to a temperature T ˜40° C. To this solution, a plasticizer (1 to 3.3% glycerol) and a catalyst were added (FIG. 2A). Upon cooling to room T, the solution transforms into a gel (FIG. 2B). In this gel, gelatin chains are crosslinked by physical bonds into a 3D network. The gel is cast into a film by evaporating the water at room temperature (FIG. 2C). Note that the plasticizer (glycerol) remains in the film after drying and ensures that the film is flexible rather than rigid.

The degradation of catalyst-loaded gelatin films upon contact with H₂O₂ is shown in FIG. 3. Here, the gelatin film contains 0.5% of MnO₂ microparticles (MPs) as the catalyst. At time t=0, a 15% H₂O₂ solution is sprayed on the film (FIG. 3A). The H₂O₂ molecules diffuse into the film and thus come into contact with the MnO₂ catalyst. The following decomposition reaction then occurs:

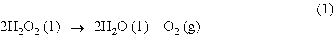

The product, O₂ gas, is released as bubbles, which are formed in and around the film within seconds (FIG. 3B). These bubbles create defects in the film, which lead to localized stresses and thus to local weakening of the film at discrete points. The catalytic reaction is intensified at these points, and the net result is the formation of visible holes in the film (FIG. 3C). The holes widen over the next several seconds and within 2 min, the film completely disintegrates into small pieces (FIG. 3D). Such degradation occurs only when H₂O₂ is added, implying that degradation can be induced on-demand. If other liquids, including pure water, are added, the film remains intact.

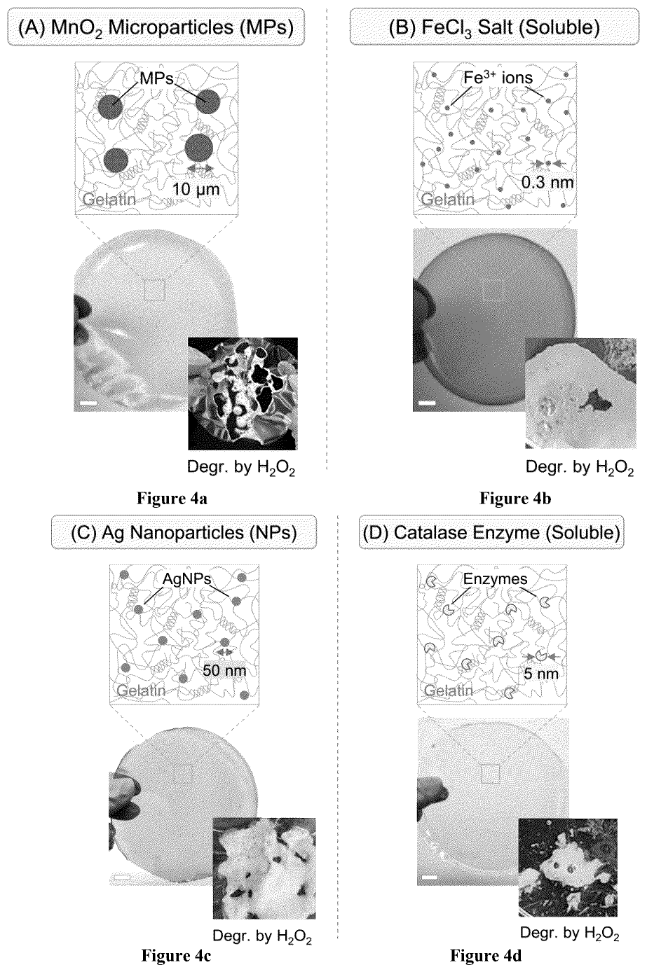

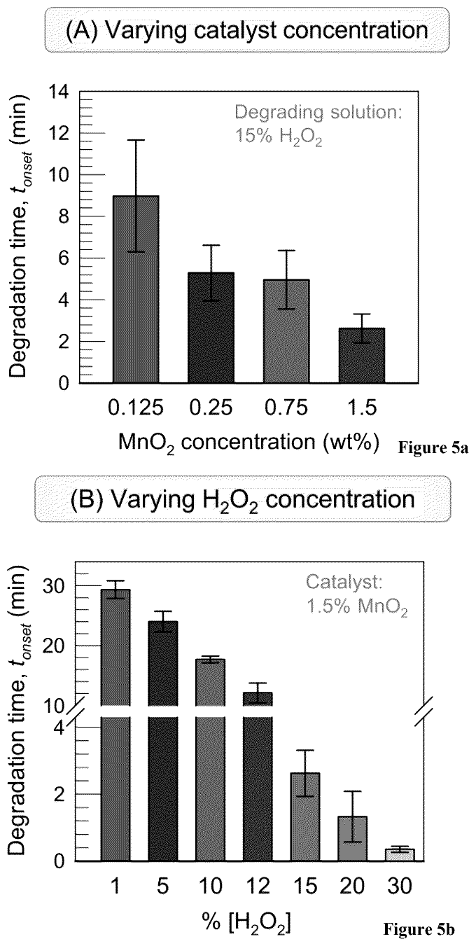

The different catalysts that can be used in the films is herein discussed. Transition metals, either in elemental form or as compounds (oxides or salts), can catalyze the decomposition of H₂O₂ by eq 1. These include iron (Fe), manganese (Mn), and silver (Ag). Several of these into gelatin films have been embedded (FIG. 4). First, insoluble particles as catalysts have already been discussed, the example in FIG. 3 being MnO₂ MPs (˜10 μm diameter). These MPs will remain suspended in the gelatin (see schematic in FIG. 4A). Note that the film with 0.5% MPs is translucent. Next are water-soluble catalytic salts like ferric chloride (FeCl₃), which are examples of homogeneous catalysts (these can be dissolved in gelatin solutions). FIG. 4B shows a dry film with 0.5% FeCl₃ and it has a yellow color characteristic of Fe³⁺ ions. Both FeCl₃ and MnO₂ are added to soil for removing contaminants and promoting plant growth; thus, both are eco-friendly catalysts. Another catalyst is silver nanoparticles (AgNPs), which can be synthesized in situ within a gelatin film. In brief, 2% silver nitrate (AgNO₃) is dissolved in a gelatin solution and heated to 45° C. Gelatin reduces Ag⁺ ions, giving rise to AgNPs (diameter ˜50 nm). FIG. 4C shows a gelatin film with embedded AgNPs. Finally, several enzymes, including catalases and peroxidases, can decompose H₂O₂. Catalase (from bovine sources) is widely available and stable over a wide range of temperatures. FIG. 4D shows a gelatin film containing 0.1% of dissolved catalase. Catalase is also abundantly present in yeast. Instead of catalase, store-bought active dry yeast can be added as a catalyst in the gelatin film. All the films shown in FIG. 4 are transparent and flexible, and they all degrade within a minute when sprayed with 15% H₂O₂ (see insets in FIGS. 4A-D).

Next, it is discussed how the degradation rates of gelatin films with catalysts can be tuned. Three variables in this regard are: the type of catalyst, the catalyst concentration, and the concentration of H₂O₂. To quantify the rate of degradation, circular films (10 cm radius, 50 μm thick) placed on a black surface at t=0 were used. H₂O₂ at a given concentration is sprayed onto the film through a mist sprayer bottle. Within seconds, the film is covered with bubbles. Thereafter, at a time corresponding to the onset of degradation (tₒₙₛₑₜ), small visible holes appear in the film. Over time, these holes grow, and the film completely disintegrates. tₒₙₛₑₜ was used to quantify the degradation rate.

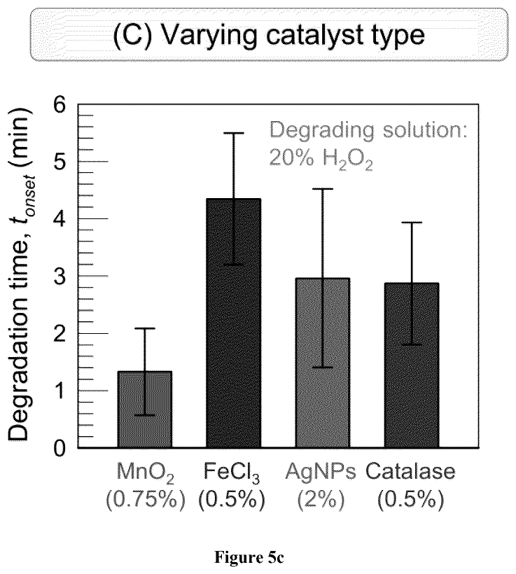

FIG. 5A shows that as the MnO₂ content is increased from 0.12% to 1.5% in the gelatin film, tₒₙₛₑₜ induced by 15% H₂O₂ decreases from 9 min to 2 min. Thus, more catalyst leads to faster degradation (as it increases the reaction rate constant). Next, the concentration of H₂O₂ ([H₂O₂]) was varied to study the degradation of gelatin films with 1.5% MnO₂ as the catalyst. The higher the [H₂O₂], the faster the degradation (FIG. 5B). This is because the reaction rate is proportional to [H₂O₂] i.e., this is a first-order reaction. Incidentally, solutions with 12% H₂O₂ are available commercially for use in homes and are labeled as “food-grade”. Thus, the films can degrade even with such dilute solutions of H₂O₂. Finally, FIG. 5C compares degradation times for different catalysts using 20% H₂O₂. tₒₙₛₑₜ is ˜1 min for 0.75% MnO₂ (particulate catalyst), ˜4 min for 0.5% FeCl₃ and ˜3 min for 0.5% catalase (both soluble catalysts), and ˜3 min for 2% AgNPs (in situ particulate catalyst). Thus, rapid degradation can be achieved with all the catalyst types.

The on-demand degradability can be imparted to various other polymer films by incorporating catalysts in them. Other biopolymers like alginate, chitosan, agar, cellulose and its derivatives etc. are being explored as alternatives to petroleum-based plastics (Table 1).

TABLE 1
Current market products and commercialization
progress of Bioplastics.

| | Biopolymer-based | |
|---|---|---|
| Biopolymer | Product (Company) | In the News |
| Alginate | Notpla Disappearing | manufacturing- |
| | packaging | today.com/news/how- |
| | | notplas-innovative- |
| | | products-are-replacing- |
| | | single-use-plastics-across- |
| | | a-range-of-applications/ |
| Chitosan | CuanSave ™ | packagingeurope.com/ |
| | (CuanTec) | introducing-cuansave-a- |
| | | flexible-film-made-from- |
| | | crustacean-shells/ |
| | | 4644.article |
| Thermoplastic Starch | Plantic ™ | www.packaging.kuraray.eu/ |
| (Plasticizer with | (Kuraray) | blog/thermoplastic-starch/ |
| Glycerol) | | |
| Agar | Loliware | www.cheddar.com/media/ |
| | | designed-to-disappear- |
| | | loliwares-seaweed-based- |
| | | straws-offer-eco-friendly- |
| | | alternative/ |
| Polyvinyl Alcohol | Monosol | www.kuraray.eu/products- |
| | | solutions/product- |
| | | ranges/monosol |

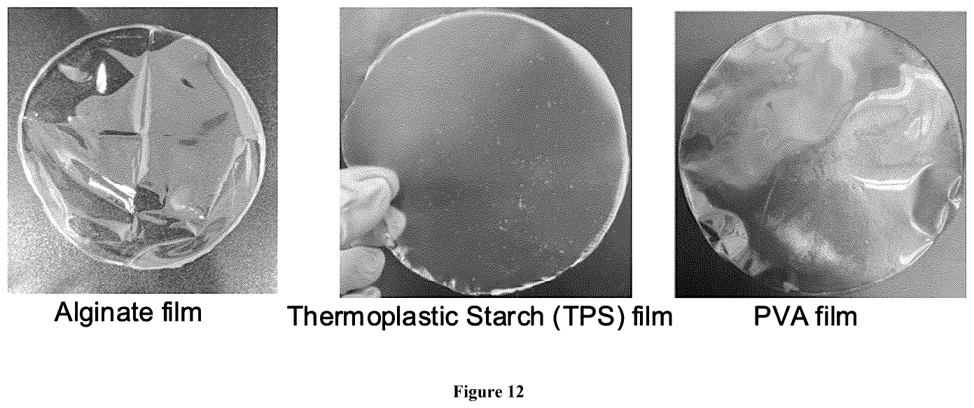

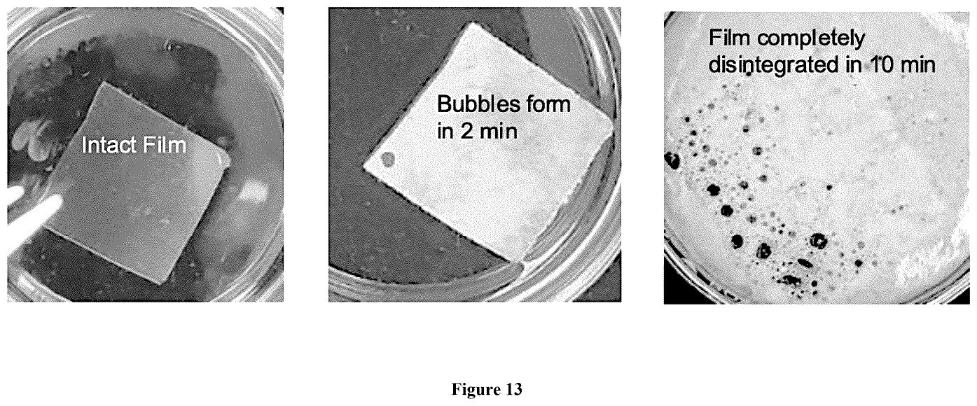

Similar to gelatin, bioplastics were synthesized based on these polysaccharides by dissolving 3% polymer and 0.3% glycerol in hot water with 0.1% MnO₂ and drying at room temperature (FIG. 12). Starch is a naturally occurring polysaccharide, which when processed with plasticizers like glycerol under high heat, transforms into thermoplastic starch (TPS). TPS has been commercialized for single use and compostable plastic applications (see Table 1). A TPS film containing 0.1% MnO₂ was synthesized by heating a 20% starch and 5% glycerol suspension at 80° C. and drying under ambient conditions (FIG. 12). All films stay intact in water. When 15% H₂O₂ is sprayed onto the films, bubbles form and the films degrade in ˜5 min. Apart from natural biopolymers, synthetic polymers like Polyvinyl Alcohol (PVA), Polylactic acid (PLA), Polycaprolactone (PCL), Polyethylene Oxide (PEO) and their blends containing 0.1% catalyst can be degraded on-demand using H₂O₂ (FIG. 13). This degradability is not without its limitations. As shown earlier, a gelatin film degrades within 2 minutes with 15% H₂O₂. If the gelatin film containing 0.5% MnO₂ is chemically crosslinked with 0.05% glutaraldehyde, it still disintegrates with 15% H₂O₂ in 15 minutes. However, if glutaraldehyde concentration is increased to 0.5%, the film remains intact and does not break down even after a few hours. Other catalyst-laden synthetic polymer films like ethyl cellulose and polystyrene also show no degradation with H₂O₂. Thus, it is shown that certain densely cross-linked biopolymer films and synthetic polymer films cannot be degraded using H₂O₂.

The mechanism of degradation is understood by closely looking at the films that break down with H₂O₂ and the ones that don't. Both natural and synthetic biopolymers contain continuous entangled networks of non-covalent interactions like hydrogen bonding, hydrophobic interactions and electrostatic interactions. As stated earlier, the bubbles of O₂ gas are formed in and around the films. When the gas bubbles expand, they exert localized stress on the surrounding matrix. This stresses continually push the entangled chains apart, leading to hole formation and degradation. Similarly for a weakly crosslinked gelatin film, the chains exhibit adequate mobility that causes widening of defects formed from gas bubbles. Highly crosslinked film does not have the chain mobility and therefore resist degradation by bubbles.

This mode of degradation may raise the concerns of increasing microplastic accumulation in the environment and in living organisms. Microplastics (plastic particles smaller than 5 mm diameter) from conventional plastics and widely used compostable materials have been shown to enter metabolic pathways and cause health issues. However, plastics were used based on natural polymers that are biodegradable under a wide range of environmental conditions, including composting and even in marine environments. Even if the film breaks into small fragments with H₂O₂, these particles will not persist or accumulate like traditional microplastics. They typically dissolve or are rapidly broken down by microbes. So, while technically any material can fragment, our plastics are not associated with the long-term environmental or toxicological concerns that conventional microplastics pose.

### Example 2. Degradation of Catalyst-Loaded Bioplastic Objects

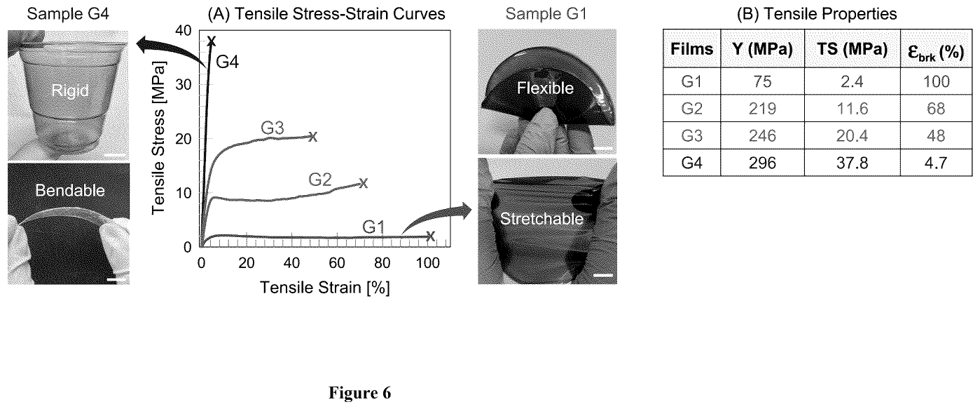

Thus far, flexible films of gelatin that can be degraded on-demand have been described. Now this is extended to stiff and strong objects of gelatin that too can be degraded the same way. The latter are made by simply reducing the plasticizer during the synthesis procedure shown in FIG. 2. FIG. 6 presents photos and stress-strain curves for four bioplastics; all made with 10% gelatin and 0.3% of MnO₂ MPs as the catalyst. Sample G1 has 3.3% of glycerol (Gly), i.e., the plasticizer is 33% of the polymer. After drying, the resulting films are transparent, flexible, and durable. Plasticizers like Gly are small, non-volatile molecules that persist in the film after drying.⁴⁰ Their presence between polymer chains weakens the interchain interactions, allowing the chains to slide past each other and thus imparting flexibility to the film. This is why the films can be folded (Photo 3) and stretched (Photo 4) without cracking or tearing. Such films could be used in packaging applications or to make bags of different kinds. On the other extreme, reducing the Gly to 1% (i.e., to 10% of the gelatin used) results in sample G4, which is a stiff but bendable solid (Photo 2). It is shown that this material can mold rigid objects, such as the cup shown in Photo 1.

Plots of tensile stress vs. strain are shown for G1 (3.3% Gly), G4 (1% Gly), and two other samples (G2 with 2% Gly and G3 with 1.4% Gly). For each sample, the Table 2 shows the Young's modulus Y, the tensile strength TS (i.e., the maximum stress at break) as well as the strain at break ε_{brk}.

TABLE 2
Young's Modulus Y, Tensile strength TS, strain at break ε_{brk}
for G1 (3.3% Gly) G2 (2% Gly), G3 (1.4% Gly) and G4 (1%) Gly.

| Films | Y (MPa) | TS (MPa) | ε_{brk} (%) |
|---|---|---|---|
| G1 | 75 | 2.4 | 99.7 |
| G2 | 219 | 11.6 | 68.3 |
| G3 | 246 | 20.4 | 48.2 |
| G4 | 296 | 37.8 | 4.7 |

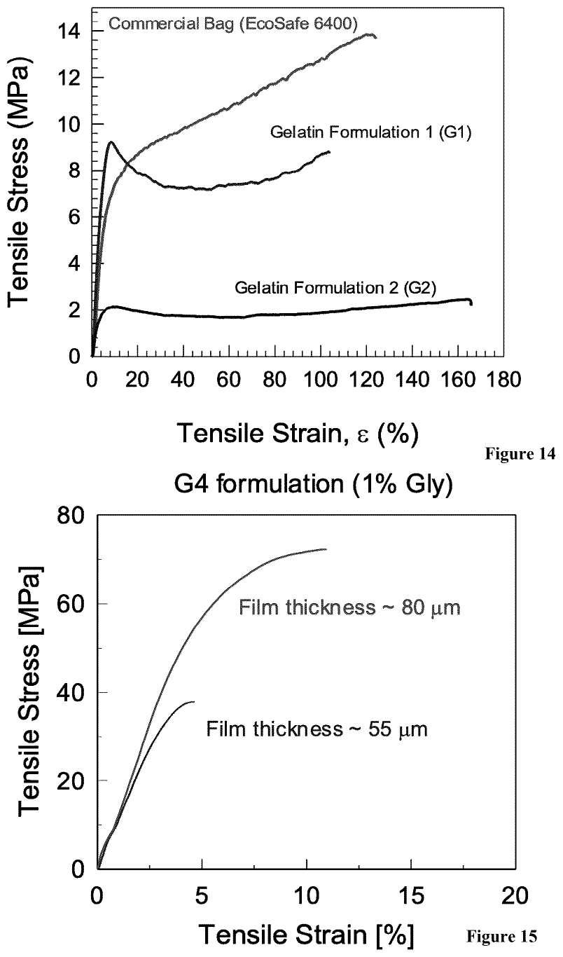

Sample G1 can be elongated to 100% of its length and its TS is 2.4 MPa. This compares well with plastic films used for commercial grocery or trash bags (see FIG. 14). As the Gly content is decreased in the sample, both Y and TS increase significantly while ε_{brk} decreases. Sample G4 has a TS of 37 MPa and this material is mechanically similar to plastics used to make solid objects like plates and cups.

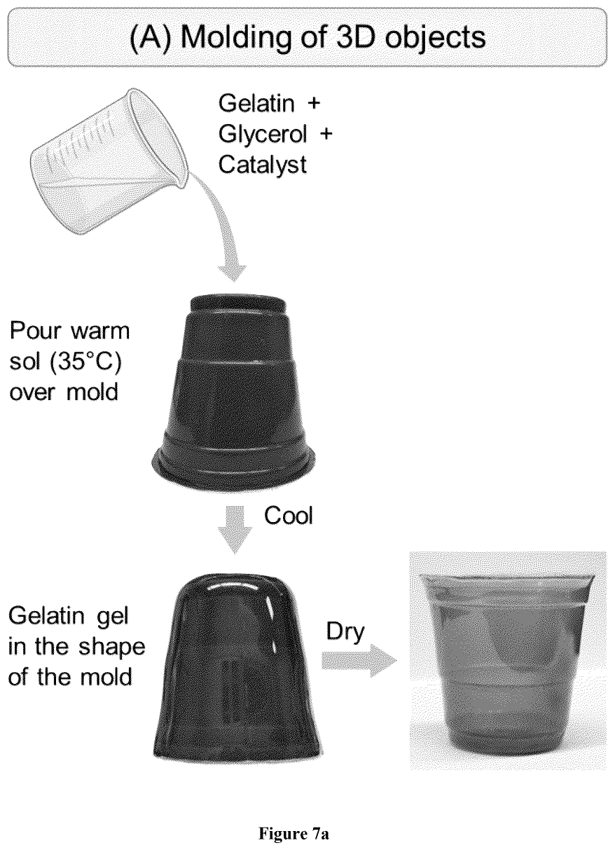

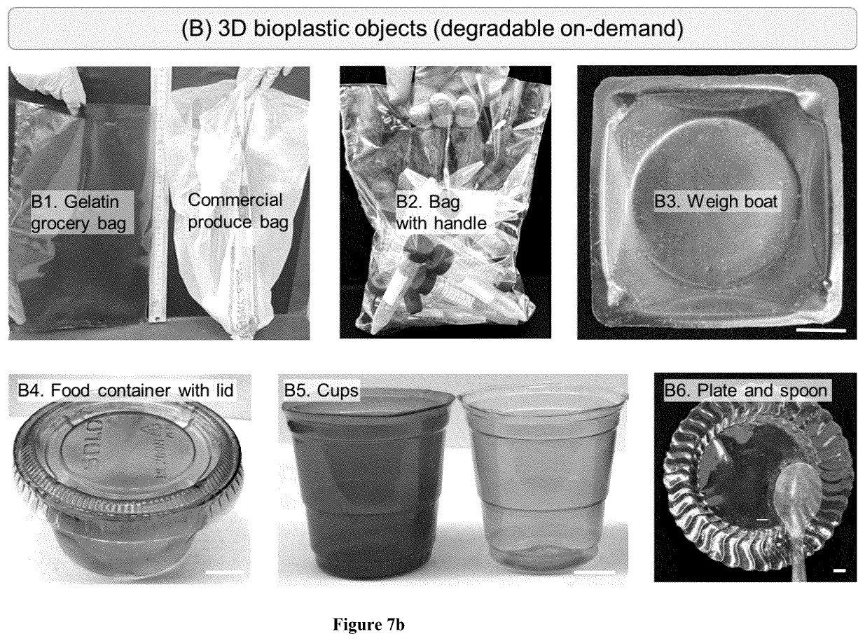

The above gelatin formulations were used to make 3D objects. In the absence of complex molding equipment, the thermoresponsive gelation exhibited by gelatin was used to facilitate molding, as shown by FIG. 7A. Gelatin forms sols at high T and gels at low T. Here, gelatin was dissolved at high concentrations (20-30%) in water at 70° C. along with glycerol and catalyst at desired concentrations. At this stage, the solution has a low viscosity akin to water. Upon cooling to T ˜35° C., the viscosity increases but the sample is not yet a gel. This viscous solution is then poured over a mold at room T (˜23° C.). The example of a mold here is a conventional plastic cup. The solution quickly transforms into a gelatin gel around the mold. Upon drying this gel at ambient T, a replica in the shape of the mold is produced.

Using the procedure detailed above, several 3D objects were created from the degradable gelatin and examples are shown in FIG. 7B. By varying the formulation from G1 to G4 (see FIG. 6), a range of mechanical properties was achieved. Another variable that dictates the strength of an object is the thickness of the gelatin layer, which was controlled through the volume of solution used in the molding process (FIG. 7A). For example, bags were made using a recipe close to G1 or G2 (higher Gly fraction) and by ensuring that the film (bag material) is thin (˜50 to 100 μm). That is, the bag material is flexible, foldable, and somewhat stretchable. B1 shows a side-by-side comparison of a gelatin bag and a commercial grocery bag. B2 shows a bag that is holding several tubes inside it. As discussed under FIG. 14, the mechanical properties of the gelatin bag material are comparable to those of commercial grocery bags or trash bags.

Next, a recipe close to G3 or G4 was used to make traditional 3D objects that are commonly found in labs or homes. These include a weigh boat (B3), a food container with both bottom and lid (B4), drinking cups (B5), and a plate and spoon (B6). All these objects show excellent strength and toughness. Note that the thickness of the plastic in these materials (˜400 to 1000 μm) is considerably more than for the bags. As discussed under FIG. 14, TS increases significantly as the thickness of the film increases and thus the mechanical properties of the base gelatin plastic used here are comparable to those of commercial plastic products made from PE, PP, PS, etc. Also, a close examination of the gelatin container and plate (B4, B6) show that this molding process accurately captures the fine details of the original objects.

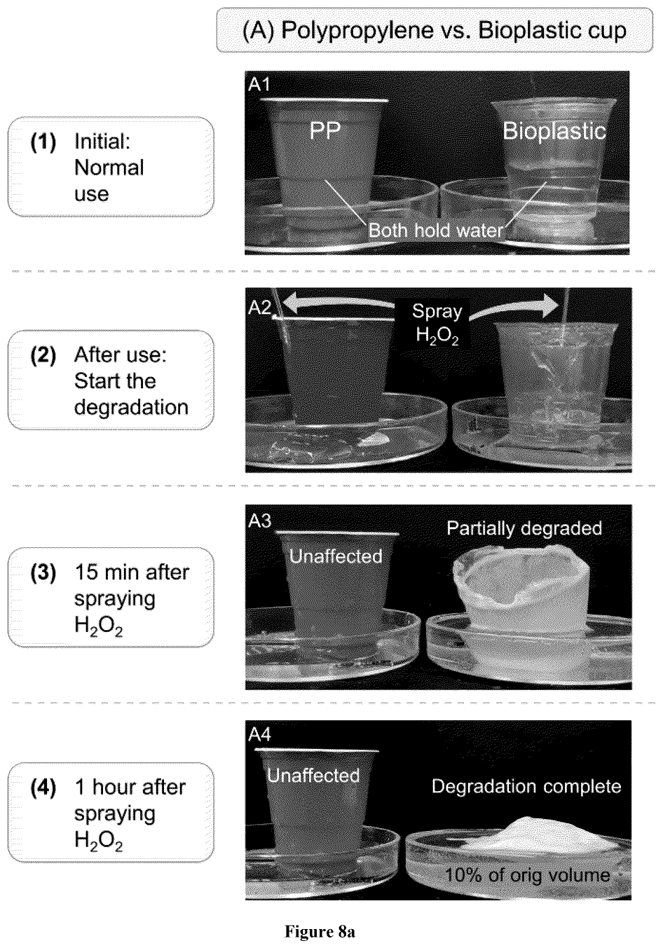

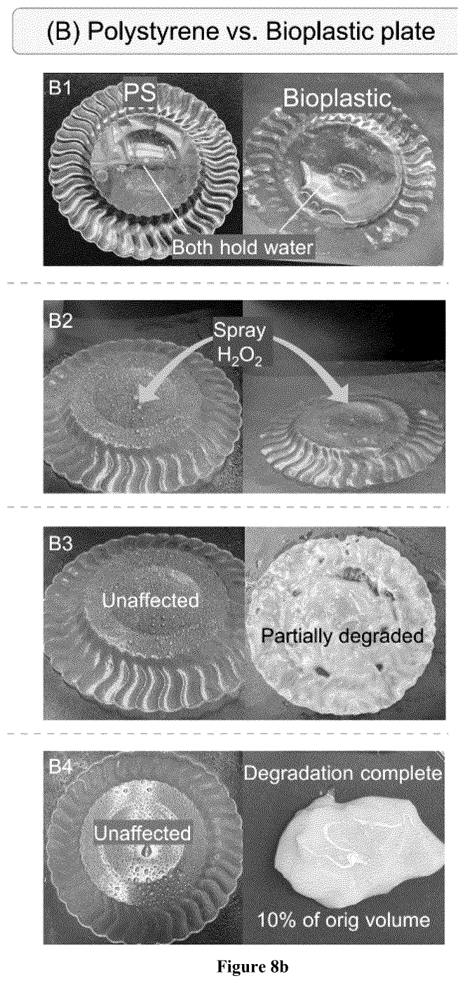

The 3D objects were examined to determine if they can degrade on-demand just like the films. Results in this regard are shown in FIG. 8A for a cup and 8B for a plate. In both cases, the objects made of bioplastic (gelatin with 0.1% MnO₂ as catalyst) are compared with similar objects made from conventional plastics. First, the bioplastic cup was compared with a plastic cup made of PP (FIG. 8A). Both cups are filled with water. and hold the water without leaks. Next, in FIG. 8B, a bioplastic plate was compared with a plate made of PS. Both plates hold considerable weight of solids as well as of liquids like water. The bioplastic cup and plate retain their integrity even after prolonged contact with liquids (i.e., the materials do not soften or degrade over time). 15% H₂O₂ was then sprayed onto the cups and plates. There is no visible effect on the PP cup and the PS plate. But in the case of the bioplastic cup and plate, O₂ bubbles immediately form all around the objects. The number of bubbles keeps growing over time and in a few minutes the objects lose their structural integrity. Both start to break and fall apart, and in about an hour, the objects are reduced to a small volume. Note the negligible volume occupied by the degraded fragments—this is 90% lower than the original volume in the case of the cup. Also, the results with the control objects (made of PP and PS) confirm that the degrading agent (H₂O₂ solution) is not so caustic or corrosive as to damage or degrade plastics on its own. Degradation occurs only with the bioplastic objects that contain the catalyst.

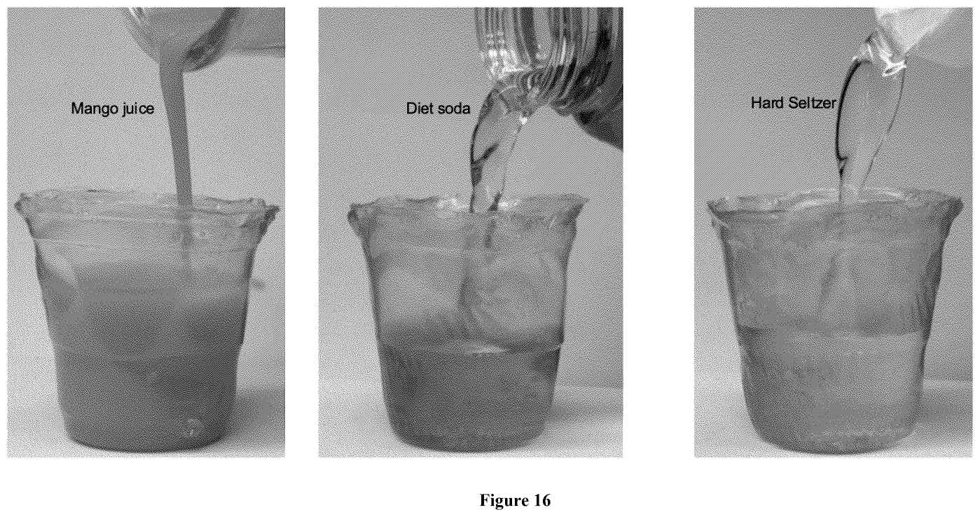

The results show that the concept of on-demand degradation can indeed be extended to real-world 3D objects. These objects are stable when they come in contact with different types of liquids such as water, soda, mango juice, and hard seltzer (FIG. 16) and are degraded only with H₂O₂. Such an approach can be used first to manage the volume of discarded waste. Large volumes of collected trash involving single-use bioplastics can be quickly reduced to a small fraction (potentially 1/10^{th}) of their original volume. Items could include plates, cups, cutlery, takeout containers, etc. In this regard, note that the timescale for completely degrading a 3D object (FIG. 8) is ˜1 h, whereas for a thin film (FIG. 3), it is only ˜1 min. The longer timescale is because the 3D objects are thicker and larger—but note that they contain very little catalyst (just 0.1% MnO₂). The timescale can be lowered by using more catalyst. Still, even a 1 h degradation is manageable in households, restaurants, or other facilities if done periodically, say once a day or week. Moreover, the fragments remaining after such degradation can then be compacted and picked up easily for transport to a composting facility. The fragments are completely converted into compost in around a day.

### Example 3. Composting of Degraded Bioplastic Fragments

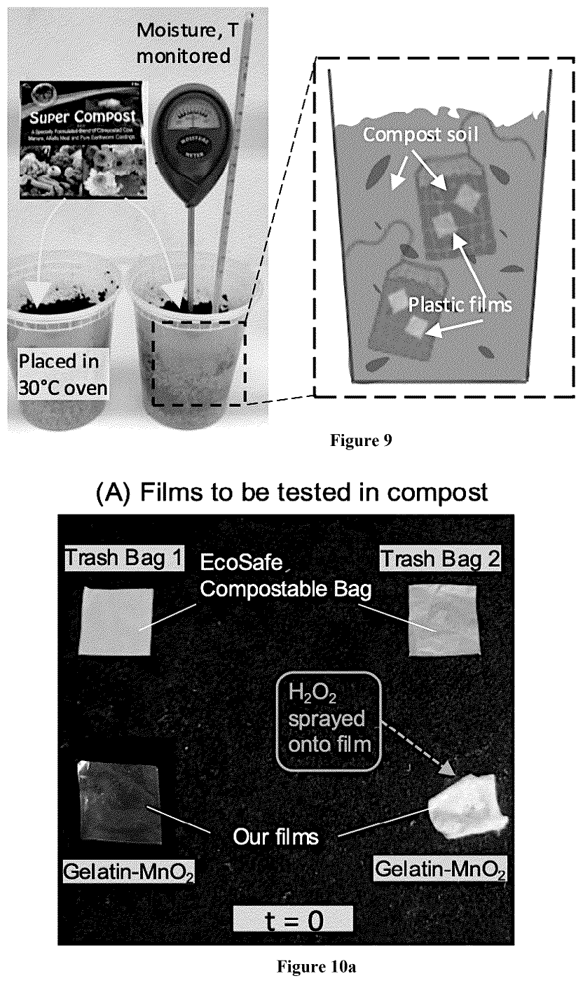

Composting studies of the degradable bioplastics were performed. As shown by the data in FIGS. 3 to 5, the gelatin films can be degraded on-demand by contact with H₂O₂. After this step, small (mm or cm-scale) fragments of the original film are left. To study this, a lab-scale composting setup based on ASTM standards was used (FIG. 9).

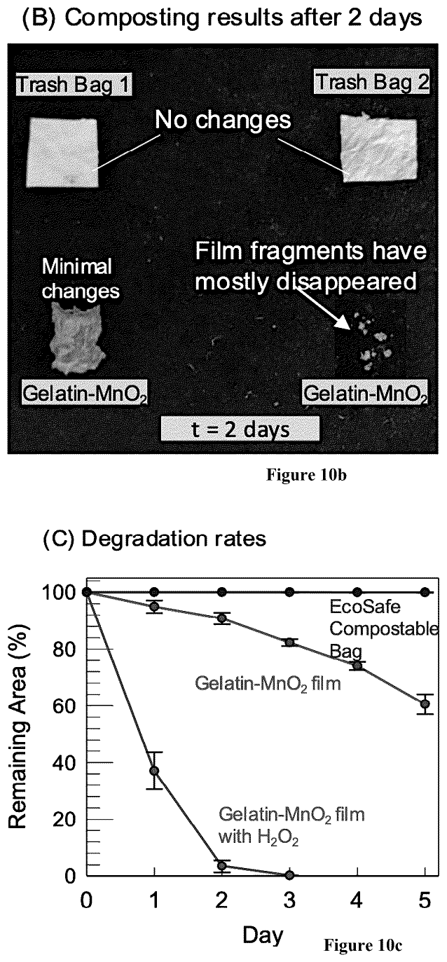

Results of degradation as shown in FIG. 10 have been obtained for a few different samples. One sample is a gelatin film with catalyst that has not been treated with H₂O₂. A second sample of the same film was lightly sprayed with H₂O₂-note in the initial photo that it is covered with bubbles but has not yet broken down into fragments. For comparison, segments were cut from two commercial plastic bags that are labelled as “compostable”. All samples were examined side by side (FIGS. 10A and 10B) and the degraded areas of films were periodically measured after carefully removing soil particles. FIG. 10C compares the percent degradation of film area for different samples for 5 days. Over this period, the samples from the “compostable” bags show no visible signs of degradation, nor any visible holes or fragments. This is consistent with the claim that the bags will take weeks to compost. In two days, the untreated gelatin film shows some minimal signs of degradation, and the degraded film area was ˜10%. ˜40% degradation in 5 days was observed, which indicates that the bioplastic is indeed compostable on its own. The complete degradation could still take a week or longer. Finally, the important result is for the gelatin film treated with H₂O₂. Results show that 97% of the film area has disappeared in 2 days, indicating that they have been degraded further and incorporated into the compost. These results show that degraded fragments can be rapidly composted. Indeed, composting of smaller materials is known to be faster because smaller sizes increase the surface area for microbial contact.

### Example 4. Coating of 3D Bioplastics to Allow Degradation Only on One Side

The potential degradation of gelatin-based bioplastic upon contact with water was examined. It was noted that the rigid 3D objects (cups and plates) remain unaffected, whereas the thin gelatin films soften upon prolonged contact with water.

To overcome this limitation, the inside of these bags were coated with a hydrophobic material that is not wetted by water, which is analogous to paper coffee cups. A common solution from nature is wax. For example, a waxy cuticle covers the leaves of plants. Similarly, insects protect themselves from dehydration largely through a layer called the epicuticle, which has a thin layer of a waxy substance. Hence, it was explored whether the gelatin films (as well as 3D objects) could be coated with a thin layer of beeswax. Beeswax is a natural, non-toxic wax that creates a water-resistant coating. It is used to coat food items as well as drug capsules before they get to stores. Compared to petroleum-derived paraffin wax, beeswax can withstand higher temperatures.

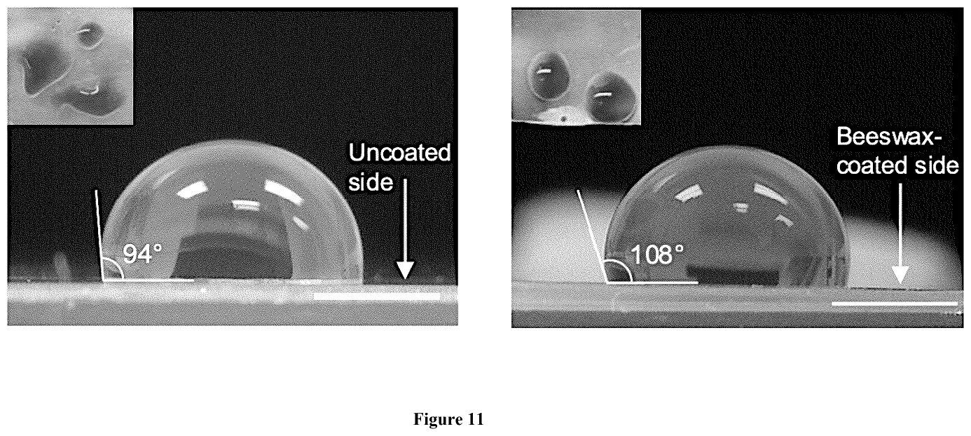

The idea is to coat one side of a gelatin film with beeswax. This ensures that the degradation by aqueous H₂O₂ can still be done from the other (uncoated) side. For example, in the case of a trash bag, the inner surface needs to be water-repellent so that wet trash can still be loaded into the bag. However, the outer surface can still be wetted by the aqueous H₂O₂, ensuring the catalytic degradation of the bag. The difference between the coated and uncoated sides is shown in FIG. 11 through measurements of the water contact angle (CA). Hydrophilic materials typically have CA<90° whereas hydrophobic materials show CA>90°. Here, it was found that an uncoated gelatin film has a CA of 94°, indicating that it is on the border between hydrophilic and hydrophobic. After coating with beeswax, CA is increased to 104°, which implies that the surface has become more hydrophobic. Indeed, consistent with this increase in CA, it was observed that water stick on the uncoated side and rolls on the beeswax-coated side, i.e., it is not wetted by water (see insets in FIG. 11).

### Example 5. Materials

The biopolymer gelatin (from porcine skin, type-A); the plasticizer glycerol (Gly); the catalysts catalase (from bovine liver) and Iron (III) chloride (FeCl₃) were all purchased from Millipore Sigma. Manganese (IV) oxide (MnO₂) was purchased from TCI America. Silver nitrate (AgNO₃) solution (0.1N) was purchased from Biopharm Inc. Compost soil and food-grade beeswax were purchased from Amazon. Deionized (DI) water was used in all experiments.

### Example 6. Film Synthesis

To prepare gelatin films, gelatin powder was dissolved in DI water by continuous stirring at a temperature of 40° C. Glycerol was then added to the solution in desired volume using micropipettes and mixed vigorously. The solution was poured into a Petri dish and left under ambient conditions for 24 hours. Upon drying, thin gelatin films were obtained.

Films containing catalysts (FeCl₃, MnO₂, catalase) were prepared the above way with the catalysts added in specified quantities, to the dissolved gelatin-glycerol solution, mixed and poured into a Petri dish.

To prepare films containing silver nanoparticles, AgNPs were synthesized in situ from AgNO₃, using the previously reported method in literature (see Kanmani, P.; Rhim, J. W. “Physicochemical properties of gelatin/silver nanoparticle antimicrobial composite films.” Food Chem. 2014, 148, 162-169). In brief, the desired volume of AgNO₃ solution was added to the homogenous gelatin-glycerol solution. The solution was continuously stirred using a stir bar and maintained at 40° C. for 24 hours, until it turns brown. The brown color indicates the formation of AgNPs. The solution was then poured into a Petri dish and dried under ambient conditions for 24 hours.

### Example 7. 3D Object Synthesis

Gelatin is dissolved at high concentrations (20-30%) in water at 70° C. and glycerol and catalyst is added to this solution. At this stage, the mixture has a low viscosity, akin to water. The mixture is then cooled to T ˜35° C., at which point the viscosity increases but the sample is not a gel. This viscous mixture can now be poured over a mold under ambient conditions until it covers the mold well without running off from the sides. Within seconds, the gelatin quickly gels in the shape of the mold. This gel is then dried at ambient T to produce the final object in the shape of the mold.

### Example 8. Film Thickness Measurement

The thickness of each film was determined using Mitutoyo 7326S Dial Thickness Gauge. For each film strip, the thickness was gauged at three separate points, and the average thickness value was recorded.

### Example 9. Tensile Tests

Tensile tests were performed using an Instron Model 68SC-05 instrument fitted with a 500N load cell. Test were conducted according to the American Society for Testing and Materials. Films were cut into 4 cm×1 cm strips and gripped between the jaws of the Instron. The tensile tests started with an initial fixture gap of 2 cm. The sampled was then stretched a rate of 0.02 mm/s and the force was recorded during this process. The data were then converted to stress vs strain plots. Three replicates were conducted for each film.

### Example 10. Lab-Scale Composting

Composting studies were done using a custom-made compost setup consistent with ASTM standards. 1 L containers were filled with compost soil. The soil was kept moist by spraying water through mist-sprayer bottles, to maintain 60% moisture content. The containers were kept in an oven at 30° C. At regular intervals, the soil was turned ensure adequate air flow. Plastic films (3 cm×3 cm) were kept in small mesh bags and buried in the soil. Mesh bags facilitate easy recovery from the soil for easy examination.

To determine the area of the film degraded, the mesh bags were recovered and placed on a flat surface. Soil particles were carefully dusted from the outside using brush. The cleaned mesh bags were placed with a ruler against white background and pictures were captured. The degraded area was calculated after processing the images in ImageJ.

### Example 11. Beeswax Coating

Several beeswax pellets were placed on a gelatin film kept on a flat surface. The wax was melted on the film using a blow-dryer until it spread out uniformly. The film was then left to cool for 10 mins. This wax coating was only one side of the film.

### Example 12. Contact Angle Measurement

Droplets (10 μL) of the liquid to be tested were placed on the film surfaces. Images of the droplets at high magnification (50×) were captured using a Dino-Lite USB Digital Microscope AM4113T. At least 5 images were analyzed using ImageJ to obtain the contact angle.

### Example 13. Conclusions

Bioplastics can be made degradable at room temperature without any complex synthesis. The idea is the use of ‘on-demand’ degradation using a benign solvent. The bioplastic contains catalyst particles, which can be in the soluble or insoluble form. When H₂O₂ is sprayed on the film, gas bubbles form in and around the film, leading to the formation of holes and eventual degradation.

This technique can be conferred to a wide range of bioplastics without requiring any modification to the existing synthesis procedures.

The quick degradation of bioplastics with H₂O₂ reduces 90% of volume occupied by the discarded waste. This technique also reduces the time required for complete conversion of plastics to useful compost to two days.

The on-demand degradation of bioplastics using H₂O₂ is unique and unlike other approaches in published literature. This approach is simple, easily scalable and can be adopted for a variety of applications.

We claim:

1. A polymeric product, said polymeric product comprising a natural polymer, a synthetic polymer, or any combination thereof, a plasticizer, and a catalyst;
wherein said catalyst is chosen from microparticles, nanoparticles, soluble chemicals, microorganisms, and enzymes;
wherein said microparticles are chosen from silver microparticles, gold microparticles, manganese (IV) oxide (MnO₂), iron (II) oxide (Fe₂O₃), iron (II, III) oxide (Fe₃O₄), and titanium oxide (TiO₂);
wherein said nanoparticles are chosen from gold nanoparticles, and silver nanoparticles;
wherein said soluble chemicals are chosen from iron chloride, ferrous sulfate (FeSO₄), ferrous chloride (FeCl₂), manganese sulfate (MnSO₄), manganese chloride (MnCl₂); and
wherein said microorganisms is yeast; and
wherein said enzymes are chosen from catalase, peroxidase, and laccase.

2. The polymeric product of claim 1, wherein said natural polymer is chosen from protein, gelatin, collagen, polysaccharide, chitosan, agar, agarose, and cellulose and its derivatives, alginate, starch, pectin, carrageenan and natural polyesters, wherein said collagen is fish, bovine, porcine ovine, or poultry collagen.

3. The polymeric product of claim 1, wherein said synthetic polymer is polyvinyl alcohol (PVA), polyesters, poly(lactic acid) (PLA), poly(lactic-co-glycolic acid) (PLGA), polyethylene oxide, polypropylene oxide, or polycaprolactone.

4. The polymeric product of claim 1, wherein said plasticizer is glycerol, sorbitol, mannitol, ethylene glycol, polyethylene glycol (PEG), propylene glycol, or polypropylene glycol (PPG).

5. A degradable polymeric product, said polymeric product comprising a natural polymer, a synthetic polymer, or any combination thereof, a plasticizer, and a catalyst;
wherein said catalyst is chosen from microparticles, nanoparticles, soluble chemicals, microorganisms, and enzymes;
wherein said microparticles are chosen from silver microparticles, gold microparticles, manganese (IV) oxide (MnO₂), iron (II) oxide (Fe₂O₃), iron (II, III) oxide (Fe₃O₄), and titanium oxide (TiO₂);
wherein said nanoparticles are chosen from gold nanoparticles, and silver nanoparticles;
wherein said soluble chemicals are chosen from iron chloride, ferrous sulfate (FeSO₄), ferrous chloride (FeCl₂), manganese sulfate (MnSO₄), manganese chloride (MnCl₂); and
wherein said microorganisms is yeast, and
wherein said enzymes are chosen from catalase, peroxidase, and laccase.

6. The degradable polymeric product of claim 5, wherein said natural polymer is chosen from protein, gelatin, collagen, polysaccharide, chitosan, agar, agarose, and cellulose and its derivatives, alginate, starch, pectin, carrageenan and natural polyesters, wherein said collagen is fish, bovine, porcine ovine, or poultry collagen.

7. The degradable polymeric product of claim 5, wherein said synthetic polymer is polyvinyl alcohol (PVA), polyesters, poly(lactic acid) (PLA), or poly(lactic-co-glycolic acid) (PLGA), polyethylene oxide, polypropylene oxide, and polycaprolactone.

8. The degradable polymeric product of claim 5, wherein said plasticizer is glycerol, sorbitol, mannitol, ethylene glycol, polyethylene glycol (PEG), propylene glycol, polypropylene glycol (PPG).

9. The degradable polymeric product of claim 5, wherein said degradable polymeric product is degradable on-command when said degradable polymeric product is contacted with a peroxide.

10. The degradable polymeric product of claim 5, wherein said degradable polymeric product is compostable in 24 hours or less.

11. The degradable polymeric product of claim 5, wherein said product is a polymer film or 3-D object.

12. The degradable polymeric product of claim 11, wherein said catalyst is embedded in the polymer film or 3-D object.

13. The degradable polymeric product of claim 5, wherein said degradable polymeric product is compostable in 3 months or less.

14. A bioplastic comprising a natural polymer or a natural polymer and synthetic polymer, a plasticizer, and a catalyst, wherein said catalyst is chosen from microparticles, nanoparticles, soluble chemicals, microorganisms, and enzymes;
wherein said microparticles are chosen from silver microparticles, gold microparticles, manganese (IV) oxide (MnO₂), iron (II) oxide (Fe₂O₃), iron (II, III) oxide (Fe₃O₄), and titanium oxide (TiO₂);
wherein said nanoparticles are chosen from gold nanoparticles, and silver nanoparticles;
wherein said soluble chemicals are chosen from iron chloride, ferrous sulfate (FeSO₄), ferrous chloride (FeCl₂), manganese sulfate (MnSO₄), manganese chloride (MnCl₂);
wherein said microorganisms is yeast;
wherein said enzymes are chosen from catalase, peroxidase, and laccase; and
wherein said natural polymer is chosen from protein, gelatin, collagen polysaccharide, chitosan, agar, agarose, and cellulose and its derivatives, alginate, starch, pectin, carrageenan and natural polyesters such as polyhydroxyalkanoates, wherein said collagen is fish, bovine, porcine ovine, or poultry collagen.

15. The bioplastic of claim 14, wherein said synthetic polymer is polyvinyl alcohol (PVA), polyesters, poly(lactic acid) (PLA), poly(lactic-co-glycolic acid) (PLGA), polyethylene oxide, polypropylene oxide, or polycaprolactone.

16. The bioplastic of claim 14, wherein said plasticizer is glycerol, sorbitol, mannitol, ethylene glycol, polyethylene glycol (PEG), propylene glycol, or polypropylene glycol (PPG).

17. A container, said container comprising a degradable polymer product of any of the preceding claims and a peroxide.
